(19) United States
(12) Patent Application Publication
(10) Pub. No.: US 2013/0252555 A1
(43) Pub. Date: Sep. 26, 2013

(54) APPARATUS AND METHOD FOR LINK SETUP USING ELECTRIC FIELD

(71) Applicant: SAMSUNG ELECTRONICS CO., LTD., Gyeonggi-do (KR)

(72) Inventor: Sae-Rome KIM, Gyeonggi-do (KR)

(73) Assignee: Samsung Electronics Co., Ltd., Gyeonggi-do (KR)

(21) Appl. No.: 13/847,074

(22) Filed: Mar. 19, 2013

(30) Foreign Application Priority Data
Mar. 20, 2012 (KR) 10-2012-0028298

(51) Int. Cl. H04W 76/02

(52) U.S. Cl. CPC H04W 76/023
USPC 455/41.2

(57) ABSTRACT

Disclosed are an apparatus and method for setting up a communication link in an electronic device by using Electric Field Communication (EFC). A method for communication link setup in a first electronic device includes: setting up an EFC link with a second electronic device; determining connection setup information of the second electronic device through the EFC link; and setting up a short range communication link with the second electronic device based on the connection setup information.

### CLAIM OF PRIORITY

This application claims priority under 35 U.S.C. §119 to an application filed in the Korean Intellectual Property Office on Mar. 20, 2012 and assigned Serial No. 10-2012-0028298, the contents of which are incorporated herein by reference.

### BACKGROUND OF THE INVENTION

1. Field of the Invention

The present disclose relates generally to short range communications, and in particular, to an apparatus and method for performing short range wireless communications.

2. Description of the Related Art

Due to the development of communication technologies, a communication system now supports various communication schemes including both voice and data services as well as a high-capacity multimedia service. In addition, the communication system also supports a short range communication scheme for sharing information between adjacent electronic devices, such as Near Field Communication, Wireless Local Area Network (WLAN), Bluetooth, and Infrared Data Association (IrDA).

When setting up a communication link through a short range communication scheme, an electronic device may face a communication link setup delay due to various connection setup operations required in the short range communication scheme. For example, when setting up a communication link by using a Bluetooth communication scheme, an electronic device enters into an inquiry substate and initiates a device search process and a connection setup process in order to search another electronic device. In this case, when the electronic device fails to search another electronic device or when the preceding inquiry substate is not interrupted, the electronic device may experience a delay for performing the inquiry substate for 10.24 seconds, for example, according to the Bluetooth standard.

Therefore, there is a need for an improved scheme to establish a connection in a short range wireless communications.

### SUMMARY OF THE INVENTION

Objects of the present disclose are to substantially solve at least the above problems and/or disadvantages and to provide at least the advantages below. Accordingly, the present disclose provides an apparatus and method for communicating data using an electric field in order to reduce a communication link setup delay.

Another aspect of the present disclose is to provide an apparatus and method for controlling a connection between electronic devices through Electric Field Communication (EFC).

Yet another aspect of the present disclose is to provide an apparatus and method for searching an electronic device for setting up a communication link through EFC.

According to a first aspect of the present disclose, a method for communication link setup in a first electronic device includes: setting up an Electric Field Communication (EFC) link with a second electronic device; determining connection setup information of the second electronic device through the EFC link; and setting up a short range communication link with the second electronic device by using the connection setup information.

According to a second aspect of the present disclose, an apparatus for a first electronic device includes: an Electric Field Communication (EFC) unit; a communication unit for short range communication; at least one processor; a memory; and at least one program stored in the memory and executed by the processor, wherein the program includes at least one instruction for setting up an EFC link with a second electronic device and setting up a short range communication link with the second electronic device through the communication unit by using connection setup information of the second electronic device determined through the EFC link.

According to a third aspect of the present disclose, an apparatus for a first electronic device includes: an Electric Field Communication (EFC) unit for setting up an EFC link with a second electronic device and determining connection setup information of the second electronic device through the EFC link; and a communication unit for setting up a short range communication link with the second electronic device by using the connection setup information of the second electronic device determined through the EFC unit.

### BRIEF DESCRIPTION OF THE DRAWINGS

The above and other objects, features and advantages of the present disclose will become more apparent from the following detailed description when taken in conjunction with the accompanying drawings in which:

FIG. 1 is a diagram illustrating a configuration of an EFC system according to an exemplary embodiment of the present disclose;

FIG. 2 is a diagram illustrating a schematic configuration of an electronic device for EFC according to an exemplary embodiment of the present disclose;

FIG. 3 is a diagram illustrating a block configuration of an electronic device for EFC according to an exemplary embodiment of the present disclose;

FIG. 4 is a diagram illustrating a process for searching an opponent electronic device through EFC by an electronic device according to an exemplary embodiment of the present disclose;

FIG. 5 is a diagram illustrating a process for searching an opponent electronic device through EFC by a Bluetooth electronic device according to an exemplary embodiment of the present disclose;

FIG. 6 is a diagram illustrating a process for setting up a communication link in a Bluetooth electronic device according to an exemplary embodiment of the present disclose;

FIG. 7 is a diagram illustrating a process for searching an opponent electronic device through EFC by a WLAN electronic device according to an exemplary embodiment of the present disclose; and

FIG. 8 is a diagram illustrating a process for setting up a communication link in a WLAN electronic device according to an exemplary embodiment of the present disclose.

### DETAILED DESCRIPTION OF EXEMPLARY EMBODIMENTS

Exemplary embodiments of the present disclose will be described herein below with reference to the accompanying drawings. For the purposes of clarity and simplicity, detailed descriptions of well-known functions or configurations will be omitted as they would unnecessarily obscure the subject matters of the present disclose. Also, the terms used herein are defined according to the functions of the present disclose. Thus, the terms may vary depending on users' or operators' intentions or practices. Therefore, the terms used herein should be understood based on the descriptions made herein.

Hereinafter, the present disclose describes teachings of controlling a connection between electronic devices through Electric Field Communication (EFC).

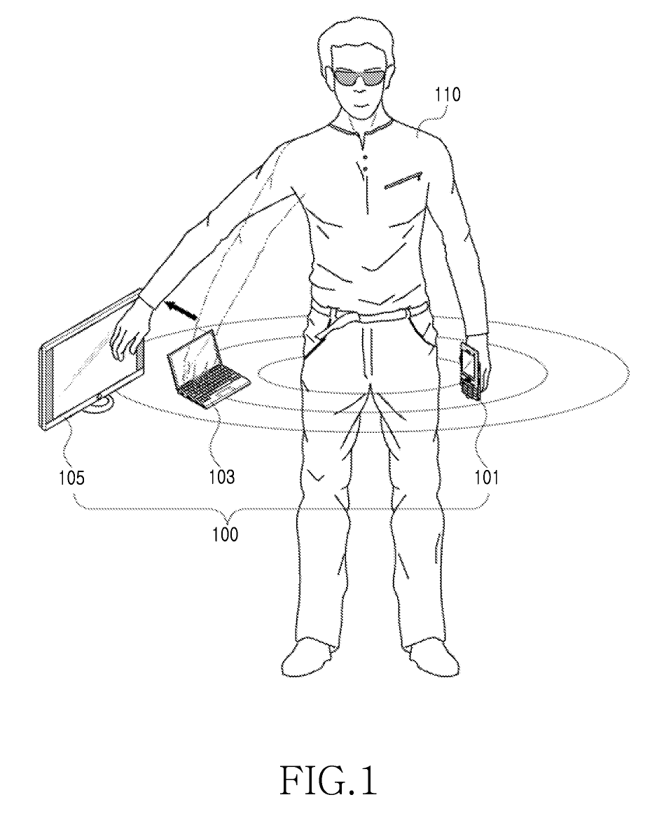

In the following description, it is assumed that a communication system communicates signals through EFC. Accordingly, the communication system may be configured as illustrated in FIG. 1

In the following description, examples of an electronic device include a mobile terminal, a personal digital assistant (PDA), a laptop computer, a smart phone, a netbook, a television, a mobile internet device (MID), an ultra mobile personal computer (UMPC), a tablet PC, a navigation device, an MP3 player, and any duplex systems.

FIG. 1 illustrates a configuration of an EFC system according to an embodiment of the present disclose.

As shown FIG. 1, the EFC system includes a plurality of electronic devices 100 and a body 110 for EFC.

The EFC supports the transmission of signals between electronic devices 101, 103 and 105 that are adjacent to the body 110 or are connected to the body 110 by using a low frequency band with near field characteristics as a channel and using the body 110 with conductivity as a communication channel. For example, the first electronic device 101 connected to a user may create an electric field of a predetermined range through the body 110 of the user and communicate signals with the second electronic device 103 or the third electronic device 105 that is located within the electric field.

As described above, the EFC is a communication scheme that communicates signals between electronic devices by using a minute electric field created at or around the body 110 of the user. Accordingly, the EFC may establish a signal transmission path through the body connected to the electronic device supporting EFC.

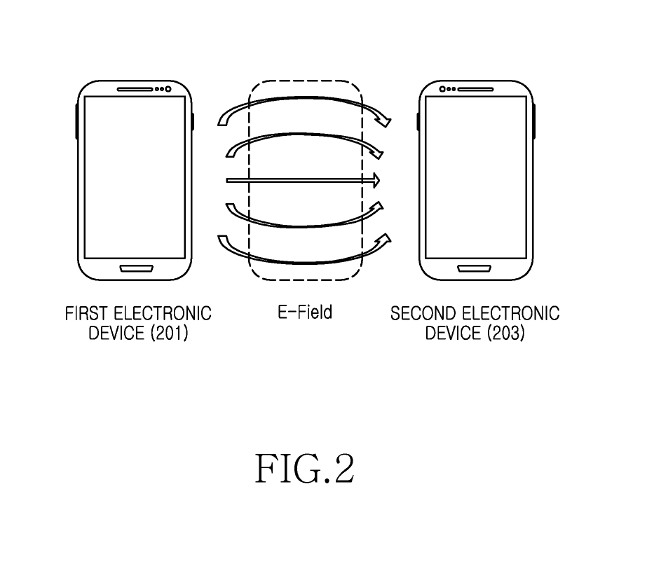

FIG. 2 illustrates a schematic configuration of an electronic device for EFC according to an embodiment of the present disclose.

As shown in FIG. 2, when a first electronic device 201 and a second electronic device 203 communicate signals by using EFC, the first electronic device 201 and the second electronic device 203 communicate signals through an electric field (E-Field) created between the first electronic device 201 and the second electronic device 203. To this end, the electronic device performing EFC includes an EFC system processing signals communicated through an electric field.

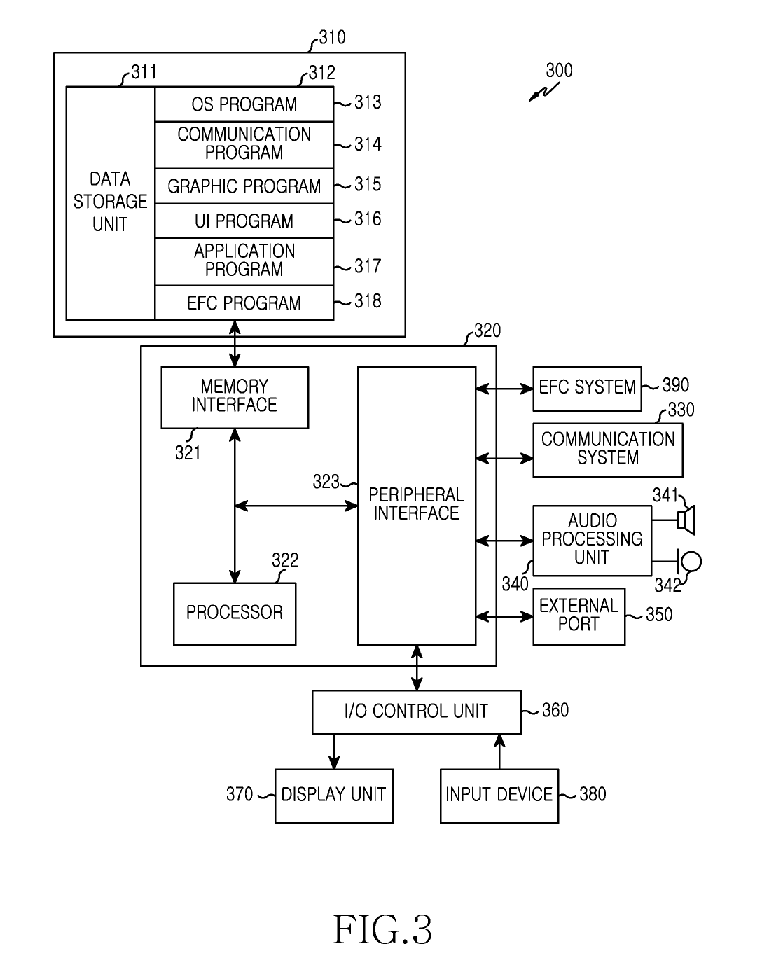

FIG. 3 illustrates a block configuration of an electronic device for EFC according to an exemplary embodiment of the present disclose.

As shown in FIG. 3, an electronic device 300 includes a memory 310, a processor unit 320, a communication system 330, an audio processing unit 340, an external port 350, an input/output (I/O) control unit 360, a display unit 370, an input device 380, and an EFC system 390. Herein, the memory 310, the communication system 330, and the external port 350 may be provided in multiples.

The memory 310 may include a data storage unit 311 for storing data generated during the execution of a program, and a program storage unit 312 for storing a program for controlling an operation of the electronic device 300.

The program storage unit 312 may include an operation system (OS) program 313, a communication program 314, a graphic program 315, a user interface (UI) program 316, at least one application program 317, and an EFC program 318. Herein, the program included in the program storage unit 312 is a set of instructions and may be referred to an instruction set.

The OS program 313 includes at least one software element for controlling a general system operation. Also, the OS program 313 may perform a function for smoothing communication between a plurality of hardware and software elements.

The communication program 314 includes at least one software element for processing data communicated through the communication system 330 or the external port 350. For example, the communication program 314 may include an instruction for performing communication connection with a second electronic device selected through the EFC system 390.

The graphic program 315 includes at least one software element for providing and displaying graphics on the display unit 370.

The UI program 316 includes at least one software element related to a user interface.

The application program 317 includes a software element for at least one application program installed in the electronic device 300.

The EFC program 318 includes at least one software element for processing data communicated through the EFC system 390. For example, the EFC program 318 may include an instruction for selecting an opponent electronic device to set a communication link through the EFC system 390.

The processor unit 320 includes a memory interface 321, at least one processor 322, and a peripheral interface 323. Herein, the memory interface 321, the processor 322 and the peripheral interface 323 included in the processor unit 320 may be integrated into at least one integrated circuit or may be implemented in separate elements.

The memory interface 321 controls the access to the memory 310 by an element such as the processor 322 or the peripheral interface 323.

The peripheral interface 323 controls the connection between the processor 322, the memory interface 321 and a peripheral I/O device of the electronic device 300.

The processor 322 uses at least one software program to perform control so that the electronic device 300 provides various multimedia services. In this case, the processor 322 executes at least one program stored in the memory 310 and provides a service corresponding to the program. For example, the processor 322 may include one or more data processors, image processors, and output control processors.

The communication system 330 performs a communication function for voice communication and data communication of the electronic device 300 through a short range communication scheme. The communication system 330 may be divided into a plurality of communication submodules supporting different communication networks. Examples of the communication networks include, but are not limited to, Wireless Local Area Network (WLAN), Bluetooth Network, Infrared Data Association (IrDA), and Near Field Communication (NFC).

The audio processing unit 340 provides an audio interface between a user and the electronic device 300 through a speaker 341 and a microphone 342.

The external port 350 includes a connection interface for connecting the electronic device 300 directly to an external electronic device or connecting the electronic device 300 to any other electronic device through a network. For example, the external port 350 includes a Universal Serial Bus (USB) port, a High-Definition Multimedia Interface (HDMI) port, and a FIREWIRE port.

The I/O control unit 360 provides an interface between the peripheral interface 323 and I/O devices such as the display unit 370 and the input device 380.

Under the control of the graphic program 315, the display unit 370 displays status information of the electronic device 300, characters input by the user, moving pictures, still pictures, and the like.

The input device 380 provides input data generated by user selection to the processor unit 320 through the I/O control unit 360. In this case, the input device 380 includes a keypad including at least one hardware button, and a touchpad detecting touch information. For example, the input device 380 provides touch information, such as a touch release, a touch motion and a touch detected through a touch pad, to the processor 322 through the I/O control unit 360.

The EFC system 390 performs a communication function for communicating signals through an electric field. For example, the EFC system 390 may include an electrode unit for creating an electric field and a communication system for processing signals communicated through the electric field.

Although not illustrated, the electronic device 300 may further include a broadband communication system performing a communication function for voice communication and data communication through a broadband communication network. Examples of the broadband communication network may include a GSM (Global System for Mobile Communication) network, an EDGE (Enhanced Data GSM Environment) network, a CDMA (Code Division Multiple Access) network, a W-CDMA (W-Code Division Multiple Access) network, an LTE (Long Term Evolution) network, and an OFDMA (Orthogonal Frequency Division Multiple Access) network.

In the above-described embodiment, the electronic device 300 includes the communication program 314 and the EFC program 318 performing control so that an initial setup for communication link setup through the communication system 330 is performed through the EFC system 390.

In another embodiment, the electronic device 300 may include a separate processor performing control so that an initial setup for communication link setup through the communication system 330 is performed through the EFC system 390.

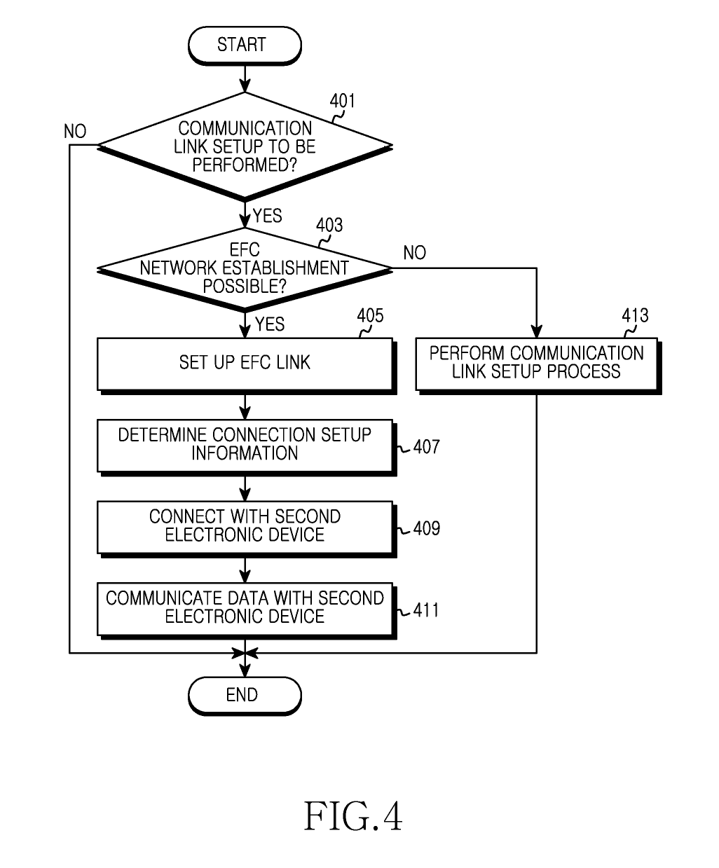

As described above, the electronic device 300 sets up a communication link with another electronic device selected through the EFC system 390 by using the communication system 330. In this case, the electronic device 300 operates as illustrated in FIG. 4.

FIG. 4 illustrates a process for searching another electronic device through EFC by an electronic device according to an embodiment of the present disclose.

Referring to FIG. 4, in step 401, the electronic device determines whether to set up a communication link for data communication through a short range communication network. For example, the electronic device determines whether an application program for data communication is executed. As another example, the electronic device may determine whether a service function for data communication is set up.

When a communication link for data communication is not set up, the electronic device ends the present algorithm.

On the other hand, when a communication link for data communication is set up, the electronic device performs step 403. In step 403, the electronic device determines whether an EFC network can be established. For example, the electronic device determines whether a second electronic device for establishing an EFC network is present in the periphery. More particularly, the electronic device determines whether there is a second electronic device for establishing a transmission path through an electric field created through a body of a user.

When an EFC network cannot be established due to the absence of an electric field detection, the electronic device performs step 413. In step 413, the electronic device performs a general communication link setup process to set up a communication link with the second electronic device for performing data communication.

On the other hand, when an EFC network can be established, the electronic device performs step 405. In step 405, the electronic device sets up an EFC link with the second electronic device. To achieve this, the electronic device transmits an EFC connection request message to the second electronic device through the EFC network. Thereafter, when the second electronic device accepts the EFC connection setup request, the electronic device sets up an EFC link with the second electronic device.

After setting up the EFC link with the second electronic device, the electronic device performs step 407. In step 407, the electronic device determines connection setup information for setting up a communication link with the second electronic device through the EFC link. For example, the electronic device exchanges connection setup information with the second electronic device through the EFC link. Here, the connection setup information includes at least one of a Bluetooth address and a Bluetooth profile of the second electronic device. Alternatively, the connection setup information includes Extensible Authentication Protocol (EAP) authentication information.

Thereafter, in step 409, the electronic device sets up a communication link with the second electronic device for short range communication by using the connection setup information. For example, when a Bluetooth scheme is used, the electronic device sets up a Bluetooth communication link with the second electronic device by using Bluetooth connection setup information determined through the EFC link. Alternatively, when a WLAN scheme is used, the electronic device sets up a WLAN communication link with the second electronic device by using WLAN connection setup information determined through the EFC link.

After setting up the communication link with the second electronic device, the electronic device performs step 411. In step 411, the electronic device communicates data with the second electronic device through the communication link with the second electronic device.

Thereafter, the electronic device ends the present algorithm.

As described above, the electronic device determines connection setup information for setting up a communication link with the second electronic device through the EFC link. That is, the electronic device performs an initial setup of a communication link corresponding to a communication scheme such as Bluetooth or WLAN by using EFC, thereby reducing a communication link setup delay. The EFC is a communication scheme that uses a body of a user of the electronic device and an electric field created near the body. Accordingly, by recognizing that the second electronic device capable of setting the EFC link is adjacent to the electronic device, without performing a separate scan for communication link setup, the electronic device recognizes that a communication link of another communication scheme can be set up.

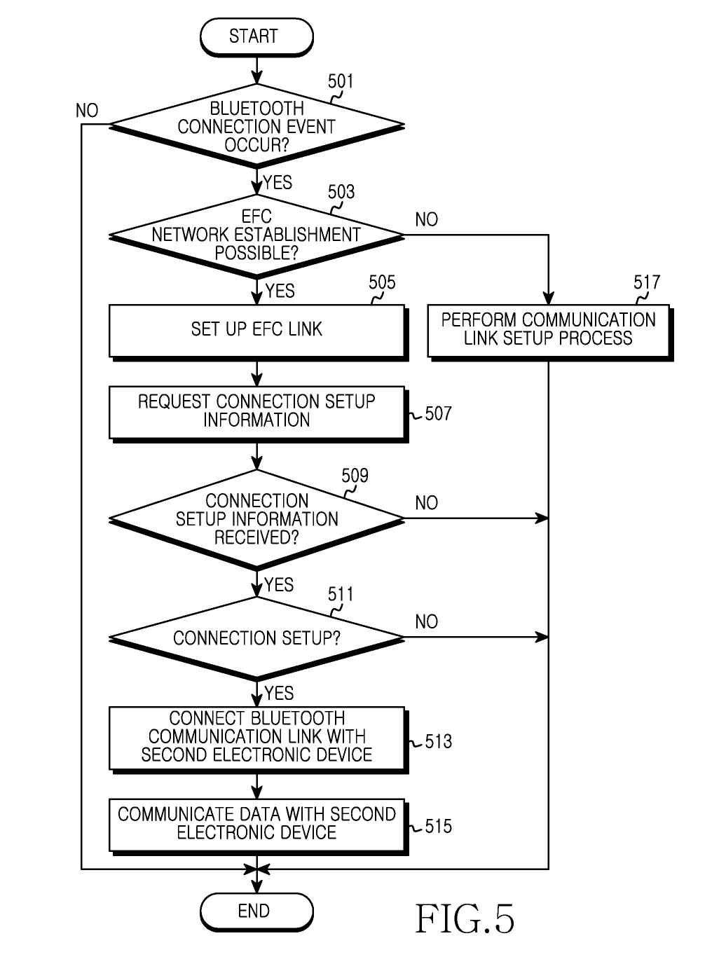

For example, when the electronic device sets up a communication link with the second electronic device by using a Bluetooth scheme, the electronic device may perform an initial setup for a Bluetooth communication link with the second electronic device by using EFC, as illustrated in FIG. 5.

FIG. 5 illustrates a process for searching another electronic device through EFC by a Bluetooth electronic device according to an embodiment of the present disclose.

Referring to FIG. 5, in step 501, the electronic device determines whether a Bluetooth connection event occurs. For example, the electronic device determines whether an application program for Bluetooth connection is selected.

When a Bluetooth connection event does not occur, the electronic device ends the present algorithm. On the other hand, when a Bluetooth connection event occurs, the electronic device performs step 503. In step 503, the electronic device determines whether an EFC network can be established. For example, the electronic device determines whether a second electronic device for establishing an EFC network is present in the periphery. That is, the electronic device may determine whether there is a second electronic device for establishing a transmission path through an electric field created through a body of a user.

When an EFC network cannot be established, the electronic device performs step 517. In step 517, the electronic device performs a general Bluetooth communication link setup process to set up a Bluetooth communication link with the second electronic device.

On the other hand, when an EFC network can be established, the electronic device performs step 505. In step 505, the electronic device sets up an EFC link with the second electronic device. For example, the electronic device transmits an EFC connection request message to the second electronic device through the EFC network. Thereafter, when the second electronic device accepts the EFC connection setup request, the electronic device sets up an EFC link with the second electronic device.

After setting up the EFC link with the second electronic device, the electronic device performs step 507. In step 507, the electronic device requests connection setup information for communication link setup from the second electronic device through the EFC link. Herein, the connection setup information includes a Bluetooth profile and a Bluetooth address of the second electronic device.

Thereafter, in step 509, the electronic device determines whether a response message to the connection setup information request is received from the second electronic device through the EFC link.

When a response message to the connection setup information request is not received from the second electronic device for a predetermined time, the electronic device recognizes that a Bluetooth communication link with the second electronic device cannot be set up. Accordingly, the electronic device ends the present algorithm. Alternatively, the electronic device may re-request connection setup information from the second electronic device.

When a response message to the connection setup information request is received from the second electronic device, the electronic device performs step 511. In step 511, the electronic device determines whether to set up a Bluetooth communication link with the second electronic device. For example, the electronic device compares the Bluetooth connection application program generated in step 501 with the Bluetooth profile of the second electronic device to determine whether to set up a Bluetooth communication link with the second electronic device.

When a Bluetooth communication link with the second electronic device cannot be set up, the electronic device recognizes that a Bluetooth communication link with the second electronic device cannot be set up. Accordingly, the electronic device ends the present algorithm.

On the other hand, when a Bluetooth communication link with the second electronic device can be set up, the electronic device performs step 513. In step 513, the electronic device sets up a Bluetooth communication link with the second electronic device by pairing with the second electronic device.

After setting up the communication link with the second electronic device, the electronic device performs step 515. In step 515, the electronic device communicates data with the second electronic device through the communication link with the second electronic device.

Thereafter, the electronic device ends the present algorithm.

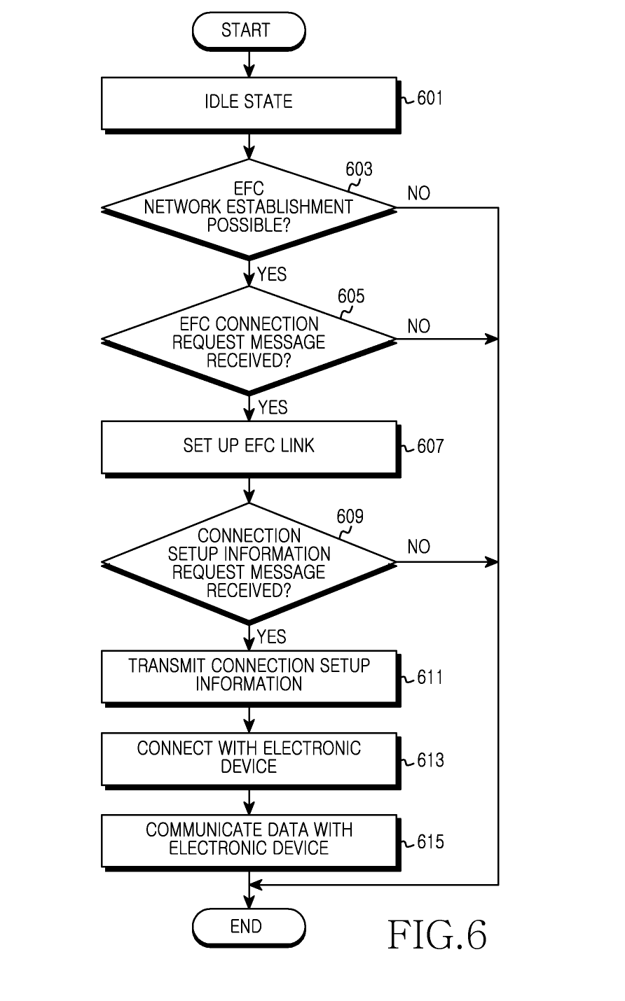

As described above, the electronic device determines connection setup information for setting up a Bluetooth communication link with the second electronic device through the EFC link. That is, the electronic device performs an initial setup for a Bluetooth communication link for EFC. In this case, the second electronic device setting a Bluetooth communication link with the electronic device operates as illustrated in FIG. 6.

FIG. 6 illustrates a process for setting up a communication link in a Bluetooth electronic device according to an embodiment of the present disclose.

Referring to FIG. 6, it is assumed that the second electronic device operates in an idle state in step 601.

Thereafter, in step 603, the second electronic device determines whether an EFC network can be established. For example, the second electronic device determines whether an electric field for EFC is detected.

When an EFC network cannot be established due to the absence of an electric field detection, the second electronic device ends the present algorithm.

On the other hand, when an EFC network can be established, the second electronic device performs step 605. In step 605, the second electronic device determines whether an EFC connection request message is received from the electronic device creating the electric field.

When an EFC connection request message is not received, the second electronic device ends the present algorithm.

On the other hand, when an EFC connection request message is received, the second electronic device performs step 607. In step 607, the second electronic device sets up an EFC link with the electronic device. For example, when an EFC connection request message is received, the second electronic device determines whether to accept the EFC connection setup request. When accepting the EFC connection setup request of the electronic device, the second electronic device may transmit an EFC connection setup accept message to the electronic device to set up an EFC link with the electronic device. On the other hand, when not accepting the EFC connection setup request of the electronic device, the second electronic device may end the present algorithm.

After setting up the EFC link with the electronic device, the second electronic device performs step 609. In step 609, the second electronic device determines whether a connection setup information request message is received from the electronic device through the EFC link.

When a connection setup information request message is not received for a predetermined time after establishment of the EFC link, the second electronic device ends the present algorithm.

On the other hand, when a connection setup information request message is received from the electronic device through the EFC link, the second electronic device performs step 611. In step 611, the second electronic device transmits connection setup information to the electronic device through the EFC link. Herein, the connection setup information includes a Bluetooth profile and a Bluetooth address of the second electronic device.

Thereafter, in step 613, the second electronic device sets up a Bluetooth communication link with the electronic device by pairing with the electronic device.

After setting up the communication link with the electronic device, the second electronic device performs step 615. In step 615, the second electronic device communicates data with the electronic device through the communication link with the electronic device.

Thereafter, the second electronic device ends the present algorithm.

In the above-described embodiment, the electronic device sets up a Bluetooth communication link with the second electronic device.

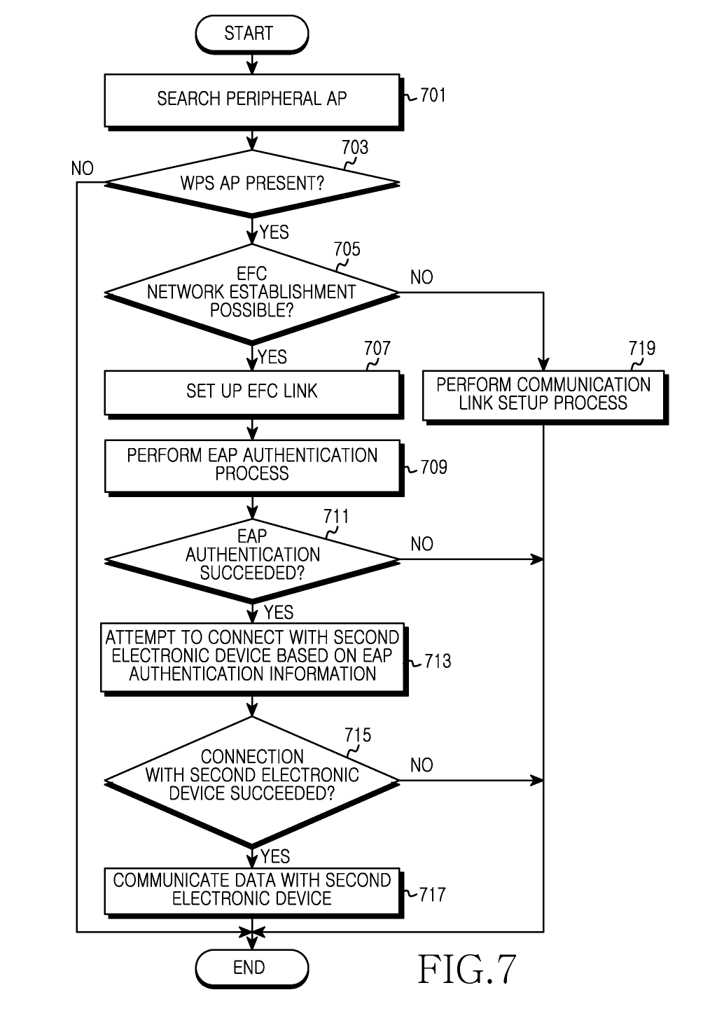

In another embodiment, the electronic device may set up a WLAN communication link with the second electronic device as illustrated in FIG. 7.

FIG. 7 illustrates a process for searching an opponent electronic device through EFC by a WLAN electronic device according to an embodiment of the present disclose.

Referring to FIG. 7, in step 701, the electronic device searches peripheral APs.

Thereafter, in step 703, the electronic device determines whether an AP supporting a WPS (Wi-Fi Protected Setup) function is present among the peripheral APs. Herein, the AP supporting a WPS function includes a WSC (Wi-Fi Simple Config Specification) IE.

When an AP supporting a WPS function is not present among the peripheral APs, the electronic device ends the present algorithm.

On the other hand, when an AP supporting a WPS function is present among the peripheral APs, the electronic device performs step 705. In step 705, the electronic device determines whether an EFC network can be established. For example, the electronic device determines whether a second electronic device for establishing an EFC network is present in the periphery. That is, the electronic device may determine whether there is a second electronic device for establishing a transmission path through an electric field created through a body of a user.

When an EFC network cannot be established, the electronic device performs step 719. In step 719, the electronic device performs a general WLAN communication link setup process to set up a WLAN communication link with the second electronic device.

On the other hand, when an EFC network can be established, the electronic device performs step 707. In step 707, the electronic device sets up an EFC link with the second electronic device. For example, the electronic device transmits an EFC connection request message to the second electronic device through the EFC network. Thereafter, when the second electronic device accepts the EFC connection setup request, the electronic device sets up an EFC link with the second electronic device.

After setting up the EFC link with the second electronic device, the electronic device performs step 709. In step 709, the electronic device performs an Extensible Authentication Protocol (EAP) authentication process with the second electronic device through the EFC link.

Thereafter, in step 711, the electronic device determines whether the EAP authentication has succeeded.

When the EAP authentication has not succeeded, the electronic device recognizes that a WLAN communication link with the second electronic device cannot be set up. Accordingly, the electronic device ends the present algorithm.

On the other hand, when the EAP authentication has succeeded, the electronic device performs step 713. In step 713, the electronic device attempts to connect with the second electronic device for WLAN communication link setup based on connection information received in the EAP authentication process. Herein, the second electronic device includes an AP or a host electronic device supporting a WLAN direct technology.

Thereafter, in step 715, the electronic device determines whether the connection with the second electronic device has succeeded.

When the connection with the second electronic device has failed, the electronic device ends the present algorithm.

On the other hand, when the connection with the second electronic device has succeeded, the electronic device performs step 717. In step 717, the electronic device communicates data with the second electronic device through the WLAN communication link with the second electronic device.

Thereafter, the electronic device ends the present algorithm.

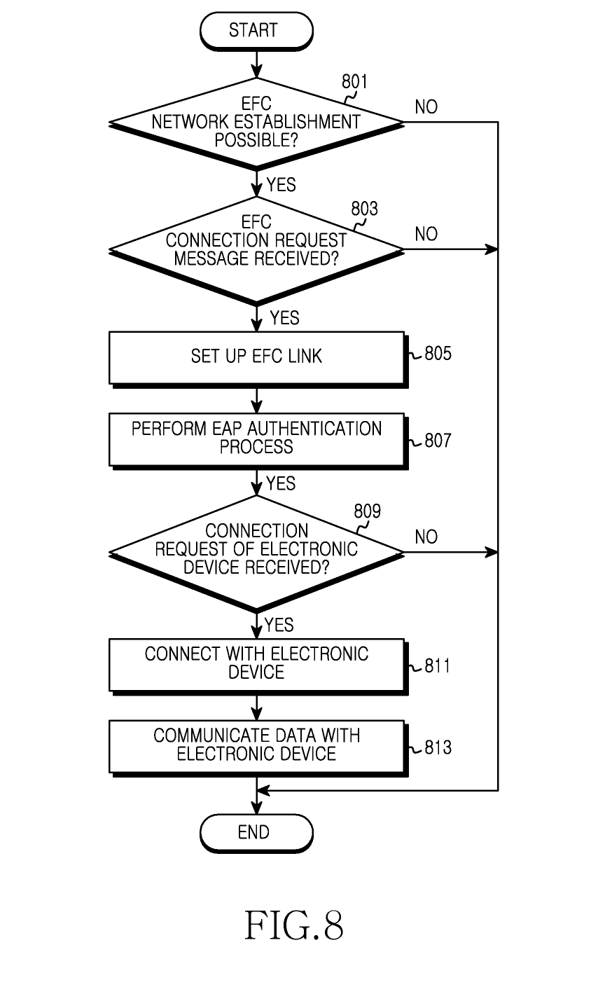

As described above, the electronic device performs an initial setup for a WLAN communication link for EFC. In this case, the second electronic device setting a WLAN communication link with the electronic device operates as illustrated in FIG. 8.

FIG. 8 illustrates a process for setting up a communication link in a WLAN electronic device according to an embodiment of the present disclose.

Referring to FIG. 8, in step 801, the second electronic device determines whether an EFC network can be established. For example, the second electronic device determines whether an electric field for EFC is detected.

When an EFC network cannot be established due to the absence of an electric field detection, the second electronic device ends the present algorithm.

On the other hand, when an EFC network can be established, the second electronic device performs step 803. In step 803, the second electronic device determines whether an EFC connection request message is received from the electronic device creating the electric field.

When an EFC connection request message is not received, the second electronic device ends the present algorithm.

On the other hand, when an EFC connection request message is received, the second electronic device performs step 805. In step 805, the second electronic device sets up an EFC link with the electronic device. For example, when an EFC connection request message is received, the second electronic device determines whether to accept the EFC connection setup request. When accepting the EFC connection setup request of the electronic device, the second electronic device may transmit an EFC connection setup accept message to the electronic device to set up an EFC link with the electronic device. On the other hand, when not accepting the EFC connection setup request of the electronic device, the second electronic device may end the present algorithm.

After setting up the EFC link with the electronic device, the second electronic device performs step 807. In step 807, the second electronic performs EAP authentication of the electronic device through the EFC link.

Thereafter, in step 809, the second electronic device determines whether the EAP-authenticated electronic device requests a connection.

When the electronic device does not request a connection for a predetermined time after the EAP authentication, the second electronic device ends the present algorithm.

On the other hand, when the EAP-authenticated electronic device requests a connection, the second electronic device performs step 811. In step 811, the second electronic device sets up a WLAN communication link with the electronic device.

After setting up the communication link with the electronic device, the second electronic device performs step 813. In step 813, the second electronic device communicates data with the electronic device through the communication link with the electronic device.

Thereafter, the second electronic device ends the present algorithm.

As described above, the connection between electronic devices is controlled through EFC, thereby making it possible to reduce a time delay for searching an opponent electronic device to set up a communication link.

The above-described methods according to the present disclose can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the disclose has been shown and described with reference to certain exemplary embodiments thereof, it will be understood by those skilled in the art that various changes in form and details may be made therein without departing from the spirit and scope of the disclose as defined by the appended claims. Therefore, the scope of the disclose is defined not by the detailed description of the disclose but by the appended claims, and all differences within the scope will be construed as being included in the present disclose.

What is claimed is:

1. A method for establishing a communication link in a first electronic device, comprising:
establishing an Electric Field Communication (EFC) link with a second electronic device;
determining connection setup information of the second electronic device through the EFC link; and
establishing a short range communication link with the second electronic device by using the connection setup information.

2. The method of claim 1, wherein the EFC link includes a communication link set up by using an electric field generated by a portion of a body.

3. The method of claim 1, wherein establishing the EFC link comprises:
determining whether there is a peripheral electronic device capable of setting up the EFC link using an electric field; and
establishing the EFC link with the second electronic device when the EFC link setup with the second electronic device is possible.

4. The method of claim 1, wherein the short range communication includes any one of a Bluetooth scheme, a Wireless Local Area Network (WLAN) scheme, an Infrared Data Association (IrDA) scheme and a Near Field Communication (NFC) scheme.

5. The method of claim 4, wherein the connection setup information includes at least one of a Bluetooth address and a Bluetooth profile of the second electronic device.

6. The method of claim 4, wherein the connection setup information includes Extensible Authentication Protocol (EAP) authentication information.

7. The method of claim 1, further comprising communicating data with the second electronic device through the short range communication link after establishing the short range communication link.

8. A first electronic device, apparatus comprising:
an Electric Field Communication (EFC) unit;
a communication unit for short range communication;
at least one processor;
a memory; and
at least one program stored in the memory and executed by the processor,
wherein the program includes at least one instruction for establishing an EFC link with a second electronic device; determining connection setup information of the second electronic device through the EFC link; and establishing a short range communication link with the second electronic device through the communication unit using connection setup information of the second electronic device

9. The apparatus of claim 8, wherein the EFC unit establish the EFC link by using an electric field generated by a portion of a body.

10. The apparatus of claim 8, wherein the processor further configured to determine whether there is a peripheral electronic device capable of setting up the EFC link using an electric field, and set up the EFC link with the second electronic device when the EFC link setup with the second electronic device is possible.

11. The apparatus of claim 8, wherein the short range communication includes any one of a Bluetooth scheme, a Wireless Local Area Network (WLAN) scheme, an Infrared Data Association (IrDA) scheme and a Near Field Communication (NFC) scheme.

12. The apparatus of claim 11, wherein the connection setup information includes at least one of a Bluetooth address and a Bluetooth profile of the second electronic device.

13. The apparatus of claim 11, wherein the connection setup information includes Extensible Authentication Protocol (EAP) authentication information.

14. The apparatus of claim 8, wherein the communication unit communicates data with the second electronic device through the short range communication link after establishing the short range communication link with the second electronic device.

15. A first electronic device, apparatus comprising:
an Electric Field Communication (EFC) unit for establishing an EFC link with an second electronic device and determining connection setup information of the second electronic device through the EFC link; and
a communication unit for establishing up a short range communication link with the second electronic device using the connection setup information.

16. The apparatus of claim 15, wherein the EFC unit establish an EFC link by using an electric field generated by a portion of a body.

17. The apparatus of claim 15, wherein the EFC unit determines whether there is a peripheral electronic device capable of setting the EFC link using an electric field, and sets up the EFC link with the second electronic device when the EFC link setup with the second electronic device is possible.

18. The apparatus of claim 15, wherein the short range communication includes any one of a Bluetooth scheme, a Wireless Local Area Network (WLAN) scheme, an Infrared Data Association (IrDA) scheme and a Near Field Communication (NFC) scheme.

19. The apparatus of claim 18, wherein the connection setup information includes at least one of a Bluetooth address and a Bluetooth profile of the second electronic device.

20. The apparatus of claim 18, wherein the connection setup information includes Extensible Authentication Protocol (EAP) authentication information.
